(19) United States
(12) Patent Application Publication
(10) Pub. No.: US 2022/0156469 A1
(43) Pub. Date: May 19, 2022

(54) PARALLELIZATION AND PIPELINING STRATEGIES FOR AN EFFICIENT ANALOG NEURAL NETWORK ACCELERATOR

(71) Applicant: Lightmatter, Inc., Boston, MA (US)

(72) Inventors: Gongyu Wang, Newton, MA (US); Cansu Demirkiran, Brookline, MA (US); Nicholas Moore, Boston, MA (US); Ayon Basumallik, Framingham, MA (US); Darius Bunandar, Boston, MA (US)

(73) Assignee: Lightmatter, Inc., Boston, MA (US)

(21) Appl. No.: 17/526,960

(22) Filed: Nov. 15, 2021

Related U.S. Application Data
(60) Provisional application No. 63/114,446, filed on Nov. 16, 2020.

(51) Int. Cl. G06J 1/00; G06N 3/04; G06N 3/063

(52) U.S. Cl. CPC G06J 1/00; G06N 3/063; G06N 3/04

(57) ABSTRACT

Parallelization and pipelining techniques that can be applied to multi-core analog accelerators are described. The techniques descried herein improve performance of matrix multiplication (e.g., tensor-tensor multiplication, matrix-matrix multiplication or matrix-vector multiplication). The parallelization and pipelining techniques developed by the inventors and described herein focus on maintaining a high utilization of the processing cores. A representative processing systemin includes an analog accelerator, a digital processor, and a controller. The controller is configured to control the analog accelerator to output data using linear operations and to control the digital processor to perform non-linear operations based on the output data.

### CROSS-REFERENCE TO RELATED APPLICATIONS

The present application claims the benefit of U.S. Provisional Application Ser. No. 63/114,446, filed on Nov. 16, 2020, under Attorney Docket No. L0858.70037US00 and entitled “PARALLELIZATION AND PIPELINING STRATEGIES FOR AN EFFICIENT ANALOG NEURAL NETWORK ACCELERATOR,” which is hereby incorporated herein by reference in its entirety.

### BACKGROUND

Deep learning, machine learning, latent-variable models, neural networks, and other matrix-based differentiable programs are used to solve a variety of problems, including natural language processing and object recognition in images. Solving these problems with deep neural networks typically requires long processing times to perform the required computation. The most computationally intensive operations in solving these problems are often mathematical matrix operations, such as matrix multiplication.

### SUMMARY OF THE DISCLOSURE

Some embodiments relate to a processing system, comprising an analog accelerator; a digital processor; and a controller configured to control the analog accelerator to output data using linear operations and to control the digital processor to perform non-linear operations based on the output data.

In some embodiments, the using linear operations comprises performing matrix multiplications.

In some embodiments, the analog accelerator comprises a photonic accelerator, and wherein controlling the analog accelerator to output the data using linear operations comprises controlling the photonic accelerator to perform matrix multiplication using light.

In some embodiments, the analog processor comprises a plurality of accelerator cores, and wherein the controller is configured to control the plurality of accelerator cores to perform the linear operations using tile parallelism.

In some embodiments, the analog processor comprises a plurality of accelerator cores, and wherein the controller is configured to control the plurality of accelerator cores to perform the linear operations using data parallelism.

Some embodiments relate to a method for processing data using a processing system comprising an analog accelerator and a digital processor, the method comprising: controlling the analog accelerator to output data using linear operations and controlling the digital processor to perform non-linear operations based on the output data.

In some embodiments, the using linear operations comprises performing matrix multiplications.

In some embodiments, the analog accelerator comprises a photonic accelerator, and wherein controlling the analog accelerator to output the data using linear operations comprises controlling the photonic accelerator to perform matrix multiplication using light.

In some embodiments, the analog processor comprises a plurality of accelerator cores, and wherein controlling the analog accelerator comprises controlling the plurality of accelerator cores to perform the linear operations using tile parallelism.

In some embodiments, the analog processor comprises a plurality of accelerator cores, and wherein controlling the analog accelerator comprises controlling the plurality of accelerator cores to perform the linear operations using data parallelism.

Some embodiments relate to a processing system, comprising an analog accelerator arranged to perform matrix multiplication; a digital processor; and a controller coupled to both the analog accelerator and the digital processor, wherein the controller is configured to obtain an input data set and a weight matrix; control the analog accelerator to perform a first matrix multiplication to produce a first output data block using a first portion of the weight matrix and at least a first portion of the input data set; control the analog accelerator to perform a second matrix multiplication to produce a second output data block using a second portion of the weight matrix and at least a second portion of the input data set; and subsequent to completion of the first matrix multiplication and prior to completion of the second matrix multiplication, control the digital processor to process the first output data block using a non-linear operation.

In some embodiments, the analog accelerator has a first accelerator core and a second accelerator core, wherein the controller is further configured to: control the analog accelerator to perform the first matrix multiplication using the first accelerator core; and control the analog accelerator to perform the second matrix multiplication using the second accelerator core.

In some embodiments, the digital processor is configured to complete the processing of the first output data block prior to completion of the second matrix multiplication.

In some embodiments, the first portion of the weight matrix comprises at least a first row of the weight matrix, and wherein the controller is configured to control the analog accelerator to perform the first matrix multiplication to produce the first output data block using the first row of the weight matrix.

In some embodiments, the second portion of the weight matrix comprises at least a second row of the weight matrix, and wherein the controller is configured to control the analog accelerator to perform the second matrix multiplication to produce the second output data block using the second row of the weight matrix.

In some embodiments, the controller is configured to control the analog accelerator to perform the first matrix multiplication using tile parallelism.

In some embodiments, the controller is configured to control the analog accelerator to perform the first matrix multiplication using data parallelism.

In some embodiments, the analog accelerator comprises a photonic accelerator, and wherein the analog accelerator is configured to perform the first matrix multiplication at least partially in an optical domain.

In some embodiments, the photonic accelerator comprises an optical multiplier configured to perform scalar multiplication in the optical domain.

In some embodiments, the photonic accelerator comprises an optical adder configured to perform scalar addition in the optical domain.

Some embodiments relate to a method for processing data using a processing system comprising an analog accelerator arranged to perform matrix multiplication and a digital processor, the method comprising: obtaining an input data set and a weight matrix; controlling the analog accelerator to perform a first matrix multiplication to produce a first output data block using a first portion of the weight matrix and at least a first portion of the input data set; controlling the analog accelerator to perform a second matrix multiplication to produce a second output data block using a second portion of the weight matrix and at least a second portion of the input data set; and subsequent to completion of the first matrix multiplication and prior to completion of the second matrix multiplication, controlling the digital processor to process the first output data block using a non-linear operation.

In some embodiments, the analog accelerator has a first accelerator core and a second accelerator core, wherein: controlling the analog accelerator to perform the first matrix multiplication comprises controlling the first accelerator core to perform the first matrix multiplication; and controlling the analog accelerator to perform the second matrix multiplication comprises controlling the second accelerator core to perform the second matrix multiplication.

In some embodiments, the method further comprising completing the processing of the first output data block prior to completion of the second matrix multiplication.

In some embodiments, the first portion of the weight matrix comprises at least a first row of the weight matrix, and wherein controlling the analog accelerator to perform the first matrix multiplication to produce the first output data block comprises controlling the analog accelerator to perform the first matrix multiplication to produce the first output data block using the first row of the weight matrix.

In some embodiments, the second portion of the weight matrix comprises at least a second row of the weight matrix, and wherein controlling the analog accelerator to perform the second matrix multiplication to produce the second output data block comprises controlling the analog accelerator to perform the first matrix multiplication to produce the first output data block using the second row of the weight matrix.

In some embodiments, controlling the analog accelerator to perform the first matrix multiplication comprises controlling the analog accelerator to perform the first matrix multiplication using tile parallelism.

In some embodiments, controlling the analog accelerator to perform the first matrix multiplication comprises controlling the analog accelerator to perform the first matrix multiplication using data parallelism.

In some embodiments, the analog accelerator comprises a photonic accelerator, and wherein controlling the analog accelerator to perform the first matrix multiplication comprises controlling the analog accelerator to perform the first matrix multiplication in an optical domain.

In some embodiments, the photonic accelerator comprises an optical multiplier, and wherein controlling the analog accelerator to perform the first matrix multiplication in the optical domain comprises performing a scalar multiplication in the optical domain using the optical multiplier.

In some embodiments, the photonic accelerator comprises an optical adder, and wherein controlling the analog accelerator to perform the first matrix multiplication in the optical domain comprises performing a scalar addition in the optical domain using the optical adder.

Some embodiments relate to a processing system configured to process a multi-layer neural network comprising first and second layers, the processing system comprising: a multi-core analog accelerator comprising first and second accelerator cores; and a controller coupled to the multi-core analog accelerator and configured to: obtain an input data set, a first weight matrix associated with the first layer of the multi-layer neural network, and a second weight matrix associated with the second layer of the multi-layer neural network; process the first layer of the multi-layer neural network, wherein processing the first layer comprises: controlling the first accelerator core to perform a first matrix multiplication to produce a first output data block using a first portion of the first weight matrix and at least a first portion of the input data set; and controlling the first accelerator core to perform a second matrix multiplication to produce a second output data block using a second portion of the first weight matrix and at least a second portion of the input data set; and process the second layer of the multi-layer neural network, wherein processing the second layer comprises: subsequent to completion of the first matrix multiplication and prior to completion of the second matrix multiplication, controlling the second accelerator core to perform a third matrix multiplication using the second weight matrix and the first output data block.

In some embodiments, the controller is further configured to control the second accelerator core to complete the third matrix multiplication subsequent to completion of the second matrix multiplication by the first accelerator core.

In some embodiments, the first portion of the first weight matrix comprises at least a first row of the first weight matrix, and wherein the controller is configured to control the first accelerator core to perform the first matrix multiplication to produce the first output data block using the first row of the first weight matrix.

In some embodiments, the second portion of the first weight matrix comprises at least a second row of the first weight matrix, and wherein the controller is configured to control the first accelerator core to perform the second matrix multiplication to produce the second output data block using the second row of the first weight matrix.

In some embodiments, the controller is configured to control the first accelerator core to perform the first matrix multiplication using tile parallelism.

In some embodiments, the controller is configured to control the first accelerator core to perform the first matrix multiplication using data parallelism.

In some embodiments, the first accelerator core comprises a first photonic core and the second accelerator core comprises a second photonic core, and wherein: controlling the first accelerator core to perform the first matrix multiplication comprises controlling the first photonic core to perform the first matrix multiplication in an optical domain; and controlling the second accelerator core to perform the second matrix multiplication comprises controlling the second photonic core to perform the second matrix multiplication in the optical domain.

In some embodiments, the first photonic core comprises an optical multiplier, and wherein controlling the first photonic core to perform the first matrix multiplication in the optical domain comprises performing a scalar multiplication in the optical domain using the optical multiplier.

In some embodiments, the first photonic core comprises an optical adder, and wherein controlling the first photonic core to perform the first matrix multiplication in the optical domain comprises performing a scalar addition in the optical domain using the optical adder.

Some embodiments relate to a method for processing a multi-layer neural network comprising first and second layers using a multi-core analog accelerator comprising first and second accelerator cores, the method comprising: obtaining an input data set, a first weight matrix associated with the first layer of the multi-layer neural network, and a second weight matrix associated with the second layer of the multi-layer neural network; processing the first layer of the multi-layer neural network, wherein processing the first layer comprises: controlling the first accelerator core to perform a first matrix multiplication to produce a first output data block using a first portion of the first weight matrix and at least a first portion of the input data set; and controlling the first accelerator core to perform a second matrix multiplication to produce a second output data block using a second portion of the first weight matrix and at least a second portion of the input data set; and processing the second layer of the multi-layer neural network, wherein processing the second layer comprises: subsequent to completion of the first matrix multiplication and prior to completion of the second matrix multiplication, controlling the second accelerator core to perform a third matrix multiplication using the second weight matrix and the first output data block.

In some embodiments, the method further comprises completing the third matrix multiplication subsequent to completion of the second matrix multiplication.

In some embodiments, the first portion of the first weight matrix comprises at least a first row of the first weight matrix, and wherein controlling the first accelerator core to perform the first matrix multiplication comprises controlling the analog first accelerator core to perform the first matrix multiplication using the first row of the first weight matrix.

In some embodiments, the second portion of the first weight matrix comprises at least a second row of the first weight matrix, and wherein controlling the first accelerator core to perform the second matrix multiplication comprises controlling the first accelerator core to perform the second matrix multiplication using the second row of the first weight matrix.

In some embodiments, controlling the first accelerator core to perform the first matrix multiplication comprises controlling the first accelerator core to perform the first matrix multiplication using tile parallelism.

In some embodiments, controlling the first accelerator core to perform the first matrix multiplication comprises controlling the first accelerator core to perform the first matrix multiplication using data parallelism.

In some embodiments, the first accelerator core comprises a first photonic core and the second accelerator core comprises a second photonic core, and wherein: controlling the first accelerator core to perform the first matrix multiplication comprises controlling the first photonic core to perform the first matrix multiplication in an optical domain; and controlling the second accelerator core to perform the second matrix multiplication comprises controlling the second photonic core to perform the second matrix multiplication in the optical domain.

In some embodiments, the first photonic core comprises an optical multiplier, and wherein controlling the first photonic core to perform the first matrix multiplication in the optical domain comprises performing a scalar multiplication in the optical domain using the optical multiplier.

In some embodiments, the first photonic core comprises an optical adder, and wherein controlling the first photonic core to perform the first matrix multiplication in the optical domain comprises performing a scalar addition in the optical domain using the optical adder.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1A is a block diagram illustrating a processing system, in accordance with some embodiments.

FIG. 1B is a representation of a matrix-matrix multiplication, in accordance with some embodiments.

FIG. 1C is a block diagram illustrating a portion of the analog accelerator of FIG. 1A, in accordance with some embodiments.

FIGS. 2A-2B are diagrams illustrating a process for performing matrix multiplication using data parallelism, in accordance with some embodiments.

FIGS. 3A-3B are diagrams illustrating a process for performing matrix multiplication using tile parallelism, in accordance with some embodiments.

FIG. 4A is a flowchart illustrating a method for processing a representative ResNet-50 deep neural network, in accordance with some embodiments.

FIG. 4B is a plot illustrating the throughput of a ResNet-50 deep neural network using data parallelism and tile parallelism, respectively, in accordance with some embodiments.

FIG. 5 is a plot illustrating a representative time breakdown for evaluating the various convolution layers of a ResNet-50 deep neural network, in accordance with some embodiments.

FIGS. 6A-6D are diagrams illustrating a process for performing matrix multiplication using data pipelining, in accordance with some embodiments.

FIG. 7 is a plot illustrating the throughput of a ResNet-50 deep neural network according to data pipelining, in accordance with some embodiments.

FIG. 8A-8B are diagrams illustrating a process for performing matrix multiplication using layer pipelining, in accordance with some embodiments.

FIG. 9 shows plots illustrating the throughput of a ResNet-50 deep neural network according to layer pipelining, in accordance with some embodiments.

### DETAILED DESCRIPTION

### I. Overview

The inventors have developed parallelization and pipelining techniques that can be applied to multi-core analog accelerators to improve performance of matrix multiplication (e.g., tensor-tensor multiplication, matrix-matrix multiplication or matrix-vector multiplication). The parallelization and pipelining techniques developed by the inventors and described herein focus on maintaining a high utilization of the processing cores.

Analog accelerators are expected to improve the complexity of a matrix multiplication operation from O(N) clock cycles, where N is a dimension of a vector (what is typically necessary in digital processors) to only O(1) clock cycles. Accordingly, analog accelerators are particularly suitable to accelerate machine learning algorithms, including deep neural networks, which rely heavily on matrix-matrix multiplications. Further, multi-core analog accelerators are expected to improve the complexity of a matrix multiplication operation beyond what is possible with a single-core analog accelerator. Multi-core accelerators include multiple computational units that, at least in theory, can work together to maximize the accelerator's throughput and minimize the latency of certain types of workload. The inventors have recognized and appreciated, however, that performing algorithms using multi-core analog accelerators presents a fundamental challenge—it is difficult to reach the accelerator's full utilization, or even nearly-full utilization. Reaching full utilization or nearly-full utilization is particularly challenging for algorithms that involve linear and non-linear operations.

In some embodiments, linear operations are performed in the analog domain using multi-core analog accelerators and non-linear operations are performed in the digital domain using digital electronics. Because digital electronics are significantly slower than analog accelerators, the system's bottleneck lies in the digital electronics. Therefore, keeping the analog accelerator fully utilized is not a trivial task.

Recognizing these challenges, the inventors have developed parallelization and pipelining techniques that can significantly increase the utilization of an analog accelerator-based computing system, thereby improving system throughput and reducing latency. One parallelization technique developed by the inventors and described herein is referred to herein as “data parallelism.” In data parallelism, each core of a multi-core analog processor processes a respective fraction of an input data set. Data parallelism is particularly useful in those circumstances in which the size of the input data set exceeds the size of the input scratchpad memory. Accordingly, this parallelism approach is limited by the size of the scratchpad.

Another parallelization technique developed by the inventors and described herein is referred to herein as “tile parallelism.” In tile parallelism, each core of a multi-core analog processor processes a respective tile of a weight matrix. Tile parallelism is particularly useful in those circumstances in which the size of the weight matrix exceeds the size of analog accelerator. Accordingly, this parallelism approach is limited by the size of the analog accelerator.

One pipelining technique developed by the inventors and described herein is referred to as “pipelined matrix multiplication.” Pipelined matrix multiplication involves linear computations in the analog domain and non-linear computations in the digital domain. In some embodiments, this technique involves computing a first partial result in the analog domain, and using the first partial result to perform a non-linear operation before a second partial result is completed in the analog domain. For example, as soon as the last tile of a first row of a weight matrix has been processed and a first output vector has been computed, a non-linear operation may be performed using the first output vector. Subsequently, as soon as the last tile of a second row of the weight matrix has been processed and a second output vector has been computed, a non-linear operation may be performed using the second output vector. This pipelining technique allows for substantial overlap between linear and non-linear operations, thereby improving the utilization of the analog accelerator.

Another pipelining technique developed by the inventors and described herein is referred to as “layer pipelining.” Typically, neural networks are aggregated into layers. Different layers may perform different transformations on their inputs. Information is passed from the first layer to the last layer, possibly after traversing the layers multiple times. The inventors have recognized and appreciated that it may be unnecessary to wait for the entire evaluation of a layer to be completed before the output activation can be passed to a subsequent layer. Accordingly, some embodiments involve pipelining the evaluation between a layer and the following layers. To that end, when parts of the output activations have been successfully calculated for a given layer, those parts can be immediately passed onto the next layer. Layer pipelining allows computing systems to overlap the computation of one layer with the computation of the next layers, thereby increasing the throughput of the overall system.

Some embodiments relate to a particular class of analog accelerators—referred to herein as “photonic accelerators” or “optical accelerators.” Photonic accelerators are accelerators that perform linear operations (e.g., multiplications and/or additions) using light (e.g., infrared light or visible light). To that end, the inventors have recognized and appreciated that using optical signals (modulated light) overcomes some of the problems with electronic computing. Optical signals travel at the speed of light in the medium in which the light is traveling. Thus, the latency of optical signals is far less of a limitation than electrical propagation delay. Additionally, virtually no power is dissipated by increasing the distance traveled by the light signals, opening up new topologies and processor layouts that would not be feasible using electrical signals. Thus, photonic accelerators offer far better speed and efficiency performance than conventional electronic accelerators.

Recognizing the benefits afforded by photonic accelerators, some embodiments relate to parallelization and pipelining techniques applied to computing systems including photonic accelerators. It should be appreciated, however, that not all embodiments are limited in this respect. In other embodiments, the parallelization and pipelining techniques developed by the inventors and described herein can be applied to computing systems including other types of analog accelerators.

### II. System Architecture

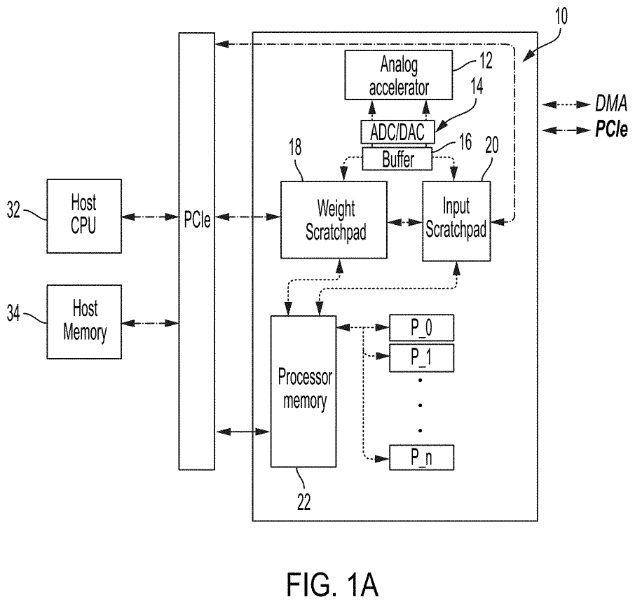

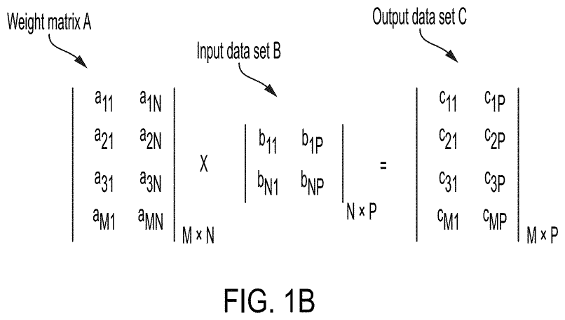

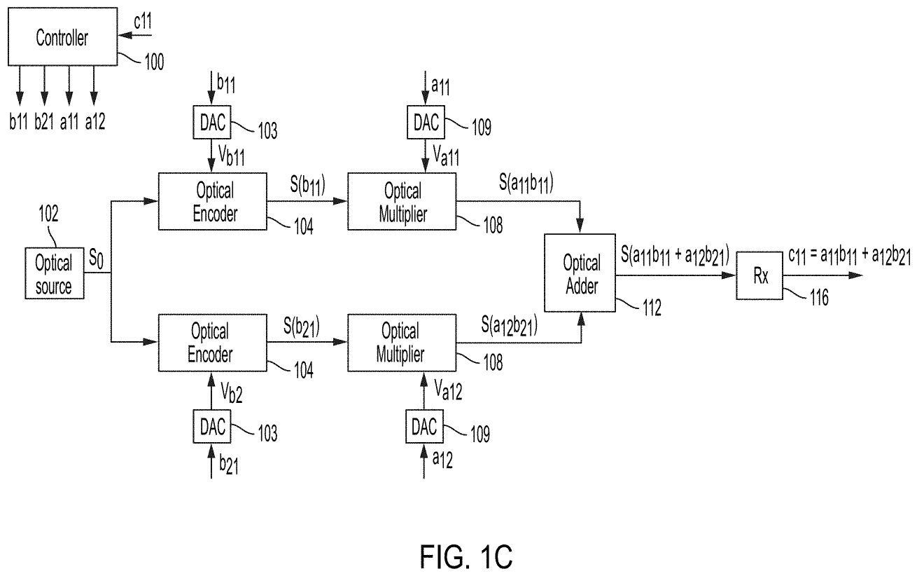

FIG. 1A is a block diagram illustrating a representative processing system, in accordance with some embodiments. The representative processing system of FIG. 1A may operate in connection with the parallelization and pipelining techniques described herein. Processing system 10 includes an analog accelerator 12, a unit 14 including analog-to-digital converters (ADCs) and digital-to-analog converters (DACs), a buffer 16, a weight scratchpad 18, an input scratchpad 20, a processor memory 22, and digital processing units P_0 . . . P_n (forming a digital processor). Having both analog and digital processing capabilities, processing system 10 may be viewed as a hybrid system. The components of processing system 10 may communicate with one another using direct memory access (DMA). Processing system 10 may be connected to a host central processing unit (CPU) 32 and a host memory 34, for example through a Peripheral Component Interconnect Express (PCIe) interface, though other suitable interfaces may be used instead.

Analog accelerator 12 includes analog circuitry arranged to perform linear operations, including for example matrix multiplications (e.g., tensor-tensor multiplications, matrix-matrix multiplications, and matrix-vector multiplications). Analog accelerator 12 may fragment matrix multiplications in terms of scalar multiplications and scalar additions. As such, analog accelerator 12 may include banks of analog multipliers each being configured to perform a scalar multiplication (or division) and banks of analog adders each being configured to perform a scalar addition (or subtraction).

Analog accelerator 12 may be arranged according to a multi-core architecture. Accordingly, analog accelerator 12 may include multiple accelerator cores. Each core may be controlled to operate independently of the other cores. In some embodiments, the cores may be controlled so that the result of an operation performed by one core is fed as input to another core. In one example, each core performs operations associated with a respective layer of a neural network. In another example, each core may perform operations associated with a respective subset of the elements of a weight matrix. In yet another example, each core may perform operations associated with a respective subset of the elements of an input data set. Other schemes are also possible. In some embodiments, the cores may be formed in accordance to a common accelerator design template. In these embodiments, the cores may have the same dimensions. In other embodiments, the cores may be slightly different from each other, and may have, for example, different dimensions.

The ADCs and DACs of unit 14 allow for communication between the analog domain and the digital domain. The ADCs translate information from the analog domain to the digital domain and the DACs translate information from the digital domain to the analog domain. For example, the DACs may translate the elements of a weight matrix, which are stored inside weight scratchpad 18, to analog signals compatible with analog accelerator 12. Similarly, the DACs may translate the elements of an input data set, which are stored inside input scratchpad 20, to analog signals compatible with analog accelerator 12. Buffer 16 is a region of a physical memory, or a dedicated memory, used to temporarily store data while it is being moved from the scratchpads to the analog accelerator. Scratchpads 18 and 20 are high-speed memories used for temporary storage of calculations, data, and other work in progress. Weight scratchpad 18 stores the elements of weight matrices while input scratchpad 20 stores the elements of input data sets. Scratchpads 18 and 20 may be implemented using any suitable memory architecture, and may be part of the same physical memory or may be physically distinct memories. Data from and to the host CPU and memory may transition through processor memory 22.

Digital processing units P_0 . . . P_n may be cores of a multi-core digital processor, for example. In some embodiments, these digital processing units may be RISC-V cores, and in other embodiments, may be in the form of look-up tables. Other processing architectures are also possible. In some embodiments, the digital processing units are controlled to perform non-linear operations (as opposed to analog accelerator 12, which may be controlled to perform linear operations). Consider for example a ResNet-50 deep neural network, which involves linear operations (e.g., convolutional layers) and non-linear operations (e.g., activation functions and batch normalization). In some embodiments, processing a ResNet-50 deep neural network using processing system 10 involves processing the networks' linear operations in the analog domain using analog accelerator 12 and processing the networks' non-linear operations in the digital domain using digital processing units P_0 . . . P_n. The digital processing units may use as input the results of the linear operations, and/or vice versa. In some embodiments, no non-linear operations of a neural network are processed by analog accelerator 12. In some embodiments, no linear operations of a neural network are processed by digital processing units P_0 . . . P_n.

FIG. 1B is a representation of a matrix-matrix multiplication, in accordance with some embodiments. Matrix A is referred to herein as “weight matrix” and the individual elements “a” of matrix A are referred to herein as “weight values” or simply “weights.” In this example, the dimension of matrix A is M×N (M rows and N columns). N may be equal to or different from M. Matrix B is referred to herein as “input data set,” and the individual elements “b” of matrix B are referred to as “input values,” or simply “inputs.” In this example, the dimension of matrix B is N×P (N rows and P columns). N may be equal to or different from P. Matrix C, which is obtained by multiplying matrix A times matrix B, is referred to herein as “output data set,” and the individual elements “c” of matrix C are referred to as “output values,” or simply “outputs.” In this example, the dimension of matrix C is M×P (M rows and P columns). In the context of artificial neural networks, matrix A can be a weight matrix, or a block of submatrix of a weight tensor, or an activation (batched) matrix, or a block of a submatrix of the (batched) activation tensor, among several possible examples. Similarly, the input data set can be one or more vectors of a weight tensor or one or more vectors of an activation tensor, for example. The matrix-matrix multiplication of FIG. 1B can be fragmented in terms of scalar multiplications and scalar additions.

In some embodiments, analog processor 12 may be implemented using optical components. In these embodiments, matrix multiplications are performed, at least partially, in the optical domain. For example, scalar multiplications may be performed in the optical domain, scalar additions may be performed in the optical domain, or both. As such, an analog accelerator may include optical multipliers and/or optical adders.

FIG. 1C illustrates a portion of a photonic analog accelerator, in accordance with some embodiments. More specifically, FIG. 1C illustrates the circuitry for computing c₁₁, the first entry of matrix C. For simplicity, in this example, the input data set has only two entries, b₁₁ and b₂₁. However, input data sets may have any suitable size.

DACs 103 are part of unit 14 and produce electrical analog signals (e.g., voltages or currents) based on the value that they receive. For example, voltage V_{b11} represents value b₁₁, voltage V_{b21} represents value b₂₁, voltage Vₐ₁₁ represents value a₁₁, and voltage Vₐ₁₂ represents value a₁₂.

Optical source 102 produces light S₀. Optical source 102 may be implemented in any suitable way. For example, optical source 102 may include a laser, such as an edge-emitting laser of a vertical cavity surface emitting laser (VCSEL), examples of which are described in detail further below. In some embodiments, optical source 102 may be configured to produce multiple wavelengths of light, which enables optical processing leveraging wavelength division multiplexing (WDM), as described in detail further below. For example, optical source 102 may include multiple laser cavities, where each cavity is specifically sized to produce a different wavelength.

The optical encoders 104 encode the input data set into a plurality of optical signals. For example, one optical encoder 104 encodes input value b₁₁ into optical signal S(b₁₁) and another optical encoder 104 encodes input value b₂₁ into optical signal S(b₂₁). Input values b₁₁ and b₂₁, which are provided by controller 100, are digital signed real numbers (e.g., with a floating point or fixed point digital representation). The optical encoders modulate light S₀ based on the respective input voltage. For example, an optical encoder 104 modulates amplitude, phase and/or frequency of the light to produce optical signal S(b₁₁) and another optical encoder 104 modulates the amplitude, phase and/or frequency of the light to produce optical signal S(b₂₁). The optical encoders may be implemented using any suitable optical modulator, including for example optical intensity modulators. Examples of such modulators include Mach-Zehnder modulators (MZM), Franz-Keldysh modulators (FKM), resonant modulators (e.g., ring-based or disc-based), nano-electro-electro-mechanical-system (NOEMS) modulators, etc.

The optical multipliers are designed to produce signals indicative of a product between an input value and a matrix value. For example, one optical multiplier 108 produces a signal S(a₁₁b₁₁) that is indicative of the product between input value b₁₁ and matrix value all and another optical multiplier 108 produces a signal S(a₁₂b₂₁) that is indicative of the product between input value b₂₁ and matrix value a₁₂. Examples of optical multipliers include Mach-Zehnder modulators (MZM), Franz-Keldysh modulators (FKM), resonant modulators (e.g., ring-based or disc-based), nano-electro-electro-mechanical-system (NOEMS) modulators, etc. In one example, an optical multiplier may be implemented using a modulatable detector. Modulatable detectors are photodetectors having a characteristic that can be modulated using an input voltage. For example, a modulatable detector may be a photodetector with a responsivity that can be modulated using an input voltage. In this example, the input voltage (e.g., Vₐ₁₁) sets the responsivity of the photodetector. The result is that the output of a modulatable detector depends not only on the amplitude of the input optical signal but also on the input voltage. If the modulatable detector is operated in its linear region, the output of a modulatable detector depends on the product of the amplitude of the input optical signal and the input voltage (thereby achieving the desired multiplication function). Optical adder 112 receives signals S(a₁₁b₁₁) and S(a₁₂b₂₁) and produces an optical signal S(a₁₁b₁₁+a₁₂b₂₁) that is indicative of the sum of a₁₁b₁₁ with a₁₂b₂₁.

Optical receiver 116 generates an electronic digital signal indicative of the sum a₁₁b₁₁+a₁₂b₂₁ based on the optical signal S(A₁₁b₁₁+a₁₂b₂). In some embodiments, optical receiver 116 includes a coherent detector, a trans-impedance amplifier and an ADC (which is part of unit 14, for example). The coherent detector produces an output that is indicative of the phase difference between the waveguides of an interferometer. Because the phase difference is a function of the sum a₁₁b₁₁+a₁₂b₂₁, the output of the coherent detector is also indicative of that sum. The ADC converts the output of the coherent receiver to output value c₁₁=a₁₁b₁₁+a₁₂b₂₁. Output value c₁₁ may be provided as input back to controller 100, which may use the output value for further processing.

An analog processor 12 may include multiple instantiations of the type of the optical circuit depicted in FIG. 1C. Each instantiation of the optical circuit may process a row of weight matrix A. In some embodiments, a photonic analog processor may include multiple cores, each core including multiple instantiations of the type of the optical circuit depicted in FIG. 1C.

### III. Data Parallelism and Tile Parallelism

The inventors have recognized and appreciated that some neural networks involve input data sets that are too large (e.g., N and/or P is too large) to fit entirely in a scratchpad 20. In other words, only a fraction of the input data can be stored in scratchpad 20 at any given time. Recognizing this limitation, the inventors have developed a parallelism technique in which each core of analog accelerator 12 processes a fraction of the input data set. In some embodiments, each core further processes the entire weight matrix. This parallelism approach (referred to as data parallelism) is therefore limited by the batch size or the number of independent data to be evaluated. The batch size is in turn limited by the size of the input scratchpad 20.

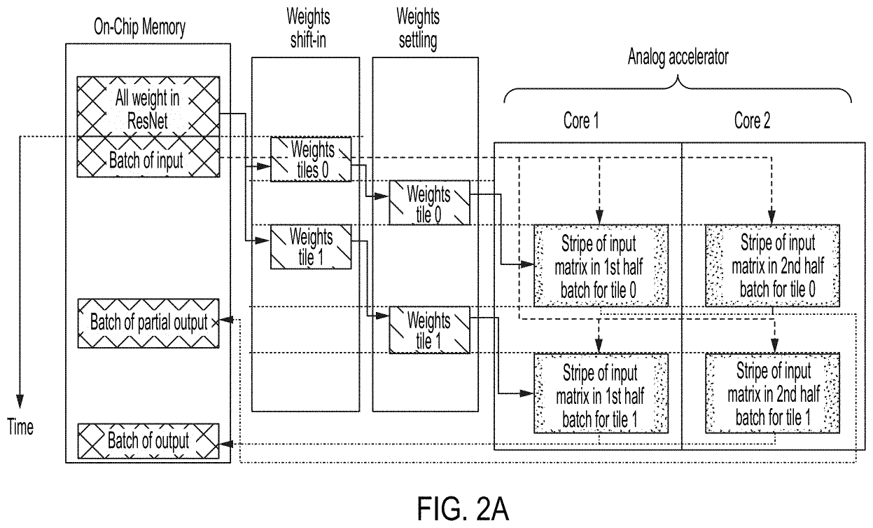

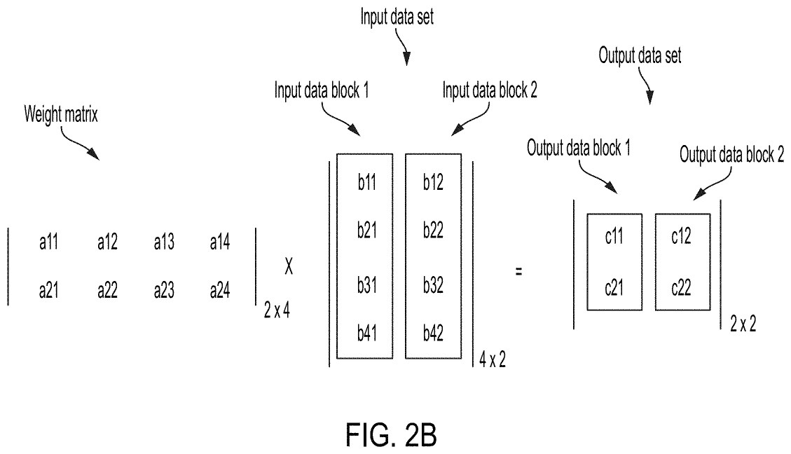

FIG. 2A is a diagram illustrating a process for performing matrix multiplication using data parallelism, in accordance with some embodiments. FIG. 2B illustrates an example of how the input data set may be broken down in accordance with the data parallelism approach described herein. By way of example, the diagram of FIG. 2A depicts the evaluation of a ResNet-50 deep neural network with an analog accelerator including two cores. In this example, weights are replicated on all analog accelerator cores, and the input data set is split between the cores. One core processes a first data subset and another core processes a second data subset. The cores operate in parallel.

The vertical axis represents the temporal axis, as indicated by the arrow labeled “time.” The block labeled “on-chip memory” represents data stored in processor memory 22. The block labeled “weight shifts-in” represent the weight matrix being loaded into weight scratchpad 18. The block labeled “weight settling” represents the weights actually being settled in analog accelerator 12. That is, the weights are not available for processing until they have settled due the circuit's finite time response. The block labeled “analog accelerator” represents the analog processing to perform matrix multiplication. In this case, analog accelerator 12 includes core 1 and core 2. With reference to FIG. 2B, core 1 multiplies the weight matrix with the input data block 1, thus producing output data block 1. Core 2 multiplies the weight matrix with the input data block 2, thus producing output data block 2. Thus, in this embodiment, each core multiplies the entire weight matrix by a respective fraction of the input matrix.

The inventors have further recognized and appreciated that some neural networks involve weight matrices too large (e.g., M and/or N is too large) to allow an analog accelerator to process the entire weight matrix in one pass. For example, a system may be designed to perform matrix multiplication using an analog accelerator where the number of rows of the weight matrix exceed the number of adders in the analog accelerator. Recognizing this limitation, the inventors have developed a parallelism technique in which each core of analog accelerator 12 processes a fraction (a tile) of the weight matrix. This parallelism approach (referred to as tile parallelism) is therefore limited by the size of the analog accelerator.

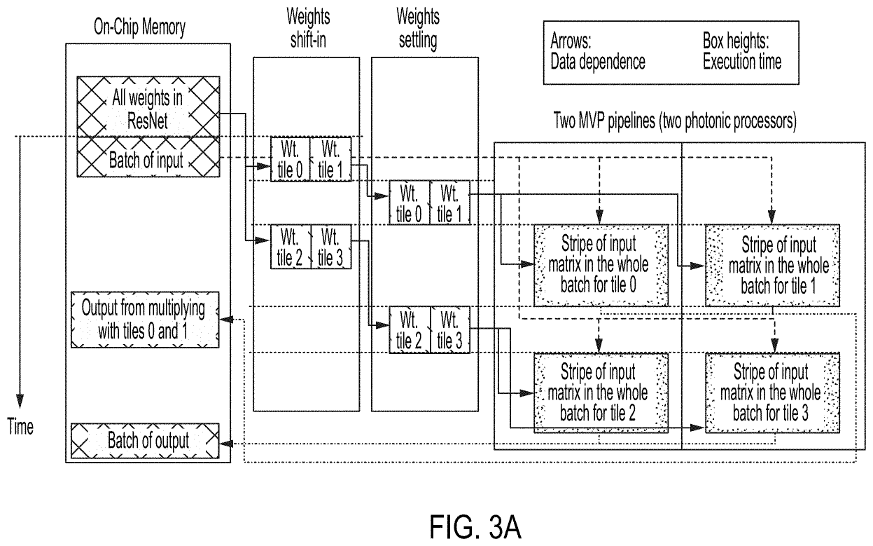

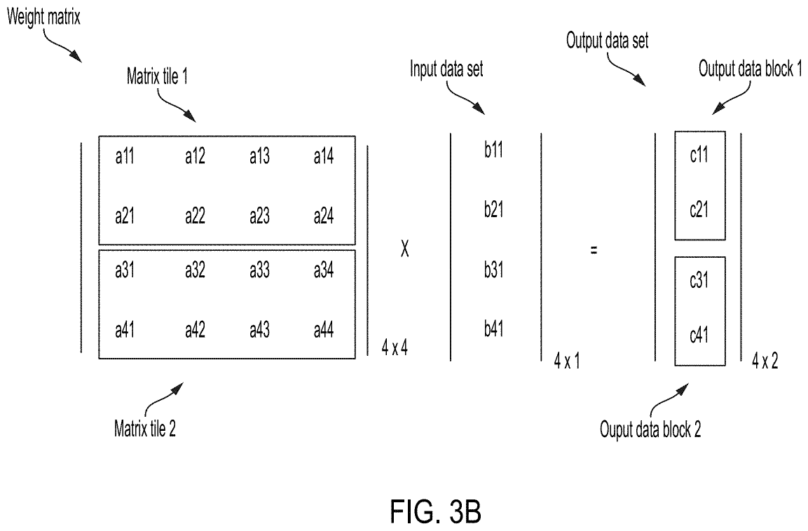

FIG. 3A is a diagram illustrating a process for performing matrix multiplication using tile parallelism, in accordance with some embodiments. FIG. 3B illustrates an example of how the input data set may be broken down in accordance with the tile parallelism approach described herein. By way of example, the diagram of FIG. 3A depicts the evaluation of a ResNet-50 deep neural network with an analog accelerator including two cores. In this example, inputs are replicated on all analog accelerator cores, and the weight matrix is split between the cores. One core processes a first tile of the weight matrix and another core processes a second tile of the weight matrix. The cores operate in parallel.

As in FIG. 2A, the vertical axis represents the temporal axis. The block labeled “on-chip memory” represents data stored in processor memory 22. With reference to FIG. 3B, core 1 multiplies matrix tile 1 with the input data set, thus producing output data clock 1. Core 2 multiplies matrix tile 2 with the input data set, thus producing output data block 2.

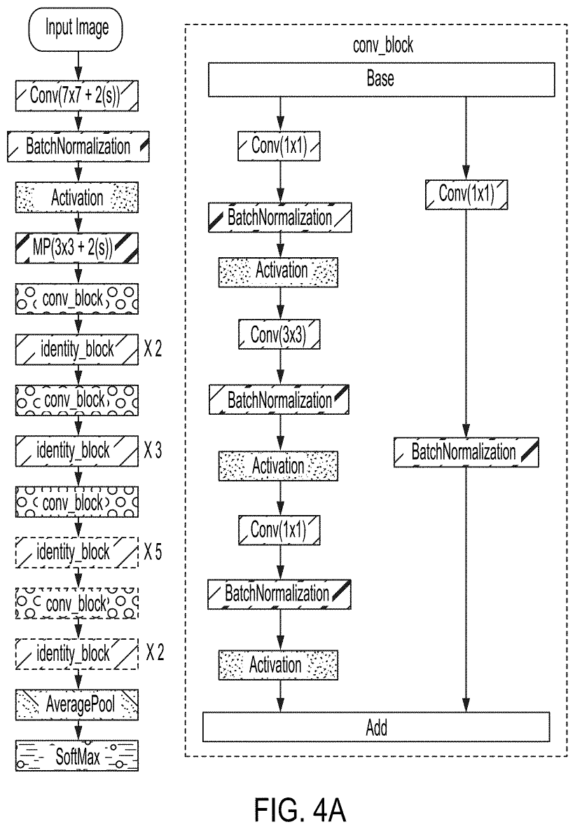

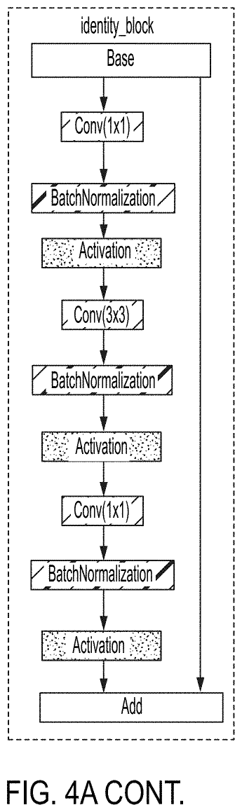

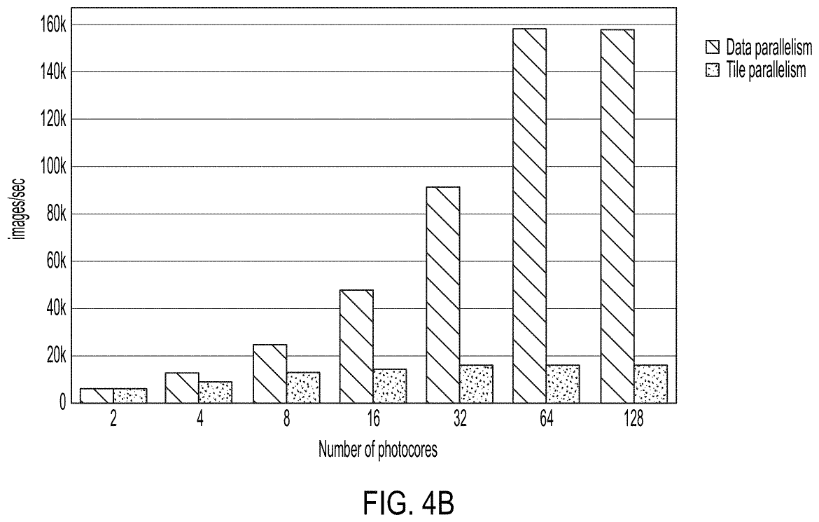

FIG. 4A is a flowchart illustrating a method for processing a representative ResNet-50 deep neural network, in accordance with some embodiments. This neural network includes linear algebra operations (e.g. the convolutional layers, labeled “Conv”). As described above, these layers are processed in the analog domain. All non-linear operations, such as the batch normalization, the (ReLU) activation, average pool, and softmax, are performed in the digital domain.

Consider for example a processing system having a 500 MB scratchpad size (shared between the weight scratchpad, input scratchpad, and the processor memory). In this example, the digital processing units operate with a clock frequency of 1 GHz. The size of each analog core is 256×256 (that is, capable of handling tiles of 256×256 elements). Assuming that a sufficiently large scratchpad is available, under these circumstances, ResNet-50 is significantly more suitable to data parallelism than tile parallelism. As batch size is increased, ideally a high throughput can be achieved with data parallelism, but a larger input scratchpad is required. Tile parallelism, on the other hand, is limited by the number of tiles. The weight matrix sizes change between 64 and 4608 between the layers in ResNet-50. For an analog processor with 256×256 elements, tile parallelism is beneficial only up to 16 cores.

FIG. 4B illustrates the throughput of a ResNet-50 utilizing tile parallelism and data parallelism, respectively. Because the analog processors have a sufficiently large tile size (256×256 in this example) compared to the size of the weight matrices, parallelizing over multiple cores using tile parallelism does not increase the throughput significantly. Tile parallelism is a valid strategy when the size of the cores is relatively smaller compared to the sizes of the network's weight matrices. In FIG. 4B, data parallelism beyond 64 photonic processors does not increase the throughput of the network because the input scratchpad is just enough to hold data up to a batch size of 64.

### IV. Pipelined Matrix Multiplication

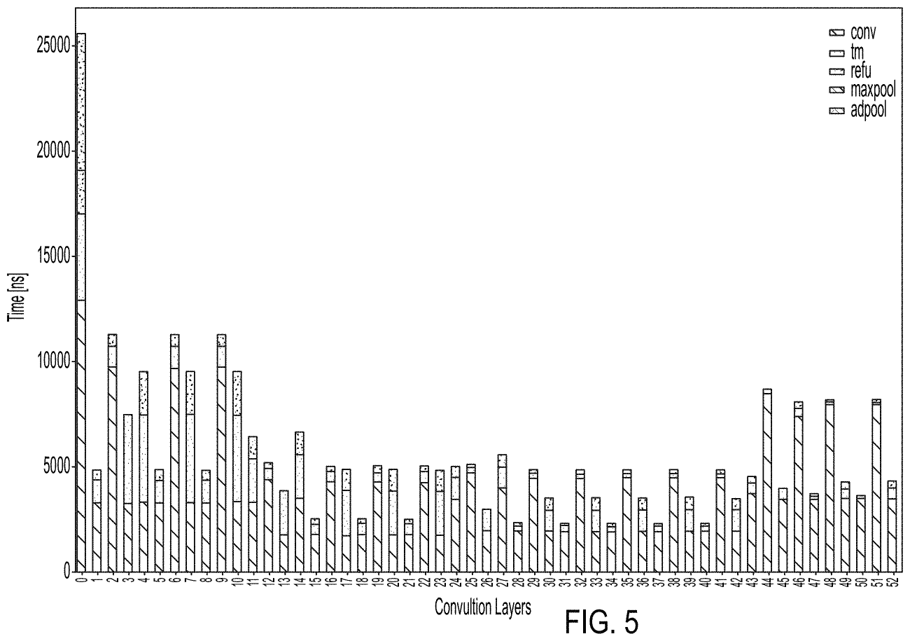

The inventors have appreciated that a typical ResNet-50 neural network is such that 99.5% of the arithmetic operations are linear algebra operations and only 0.5% of the arithmetic operations are non-linear operations. Other neural networks have similar breakdowns between linear and non-linear operations. FIG. 5 is a plot illustrating a representative time breakdown for evaluating the various convolution layers of a ResNet-50 deep neural network, in accordance with some embodiments. More specifically, FIG. 5 shows the time breakdown between the linear algebra operations (labeled ‘cony’ for convolutions) and the nonlinear operations (labeled ‘bn’ for batch-norm, ‘relu’ for ReLU activation function, ‘maxpool’ for max pooling operation, and ‘adpool’ for adaptive average pool). As can be appreciated from this lot, the evaluation time of each layer is vastly dominated by the time to perform the convolution operations. For ResNet-50, generally the nonlinear operations can only be started when the linear algebra operations on the vector to be operated on with nonlinear functions have been completed. The inventors have recognized, however, that it is not necessary to wait for all the linear algebra operations (e.g., cony) to be completed before the nonlinear operations can be started by the digital processor cores. Instead, as soon as one output vector of the output matrix is complete, the data can immediately be transferred to the digital processor memory and be operated on by the parallel digital processors.

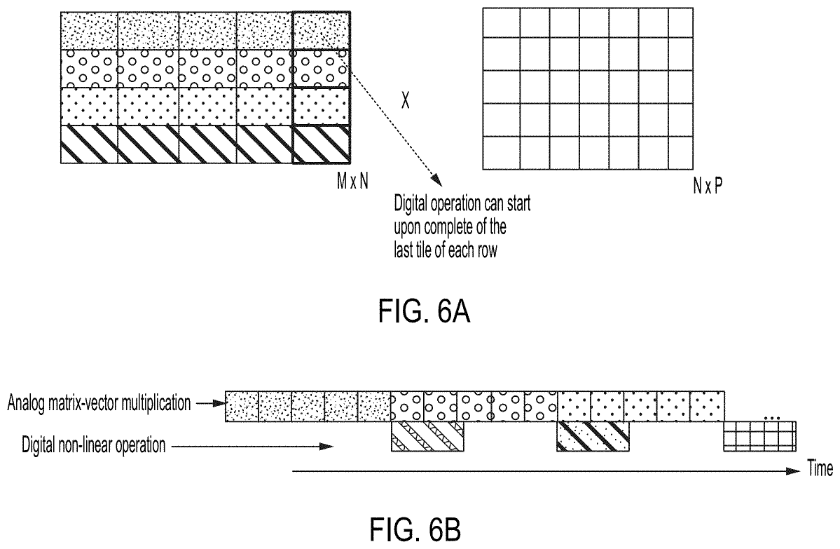

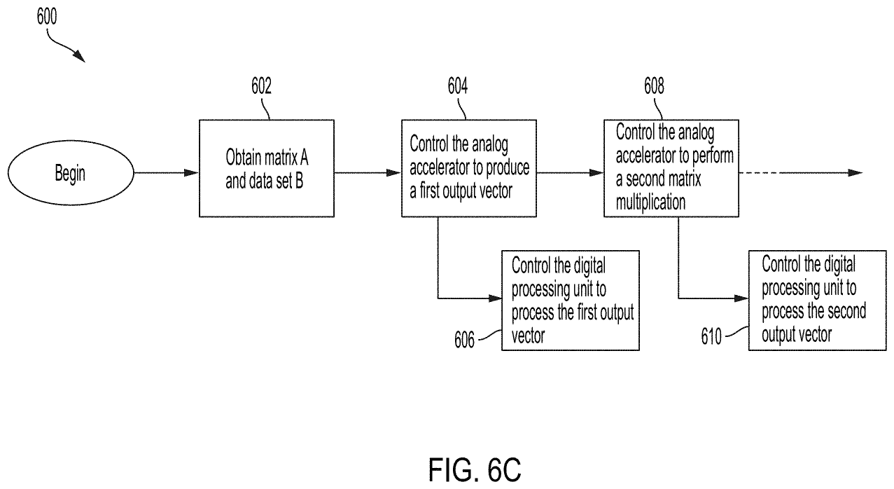

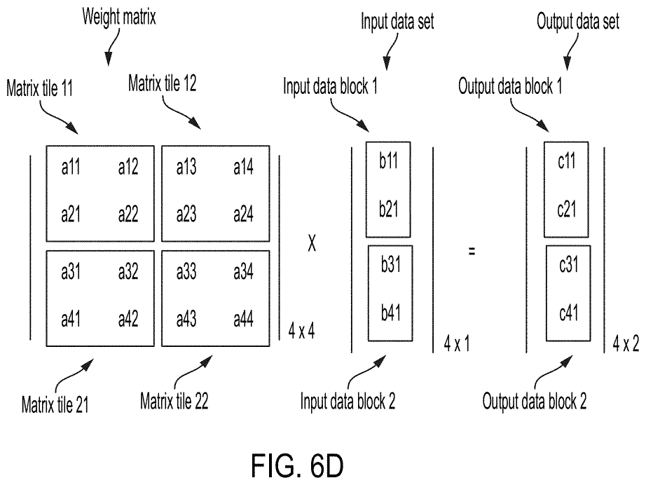

Consider the matrix multiplication between a weight matrix of size M×N and an input matrix data of size N×P as shown in FIG. 6A. In some embodiments, to reduce the amount of time required for shifting in weight tiles and having the weights settle inside the analog accelerator, the weight tiles may be processed row-by-row from left to right. As such, the computation of the output matrix of size M×P may also be completed on the row-by-row basis. Because the matrix-matrix multiplication is broken down in terms of matrix-vector multiplication within the analog accelerator, as soon as the last tile in each row is loaded into the analog processor and the first input vector has been processed through the analog processor, the calculation for a vector in the output matrix has been completed. The digital nonlinear operations for that vector can immediately be started (without having to wait until the following row has been processed). FIG. 6B is a time diagram illustrating this scheme. Here, non-linear operations are performed as soon as a row of a weight matrix has been processed and a vector has been generated. Notably, a nonlinear operation can be performed with respect to the output of a row calculation before the system has processed (e.g., has completed or has begun to process) the output of another row.

The inventors have recognized that this pipelining strategy is more efficient than the naive pipelining strategy, where the digital nonlinear operations are only started when the entire output matrix has been calculated. The pipelining strategy described herein allows significant overlap between the matrix multiplication operations for the last tile of each column and the digital nonlinear operations as sketched in the time sequence diagram in FIG. 6B.

FIG. 6C is a flowchart illustrating a representative process for computing a neural network using pipelines matrix multiplication, in accordance with some embodiments. An example multiplication is illustrated in FIG. 6D, where a weight matrix is multiplied by an input data set to produce an output data set. Process 600 begins at step 602, in which a controller coupled to both an analog accelerator and a digital processor obtains an input data set and a weight matrix (e.g., those illustrated in FIG. 6D).

At step 604, the controller controls the analog accelerator to perform a first matrix multiplication to produce a first output data block using a first portion of the weight matrix and at least a first portion of the input data set. With reference to FIG. 4D, output data block 1 may be produced by multiplying the row including matrix tile 11 and matrix tile 12 by input data blocks 1 and 2.

At step 606, the controller controls the digital processor to process the first output data block using a non-linear operation. For example, the controller may process output data block 1 using a batch-norm, an activation function, a max pooling operation, or an adaptive average pooling operation.

At step 608, the controller controls the analog accelerator to perform a first matrix multiplication to produce a second output data block using a second portion of the weight matrix and at least a second portion of the input data set. With reference to FIG. 4D, output data block 2 may be produced by multiplying the row including matrix tile 21 and matrix tile 2 by input data blocks 1 and 2. Notably, step 606 is performed subsequent to completion of step 604 but prior to completion of step 608. For example, a non-linear operation may be performed before output data block 2 may be produced.

At step 610, the controller controls the digital processor to process the second output data block using a non-linear operation. For example, the controller may process output data block 2 using a batch-norm, an activation function, a max pooling operation, or an adaptive average pooling operation.

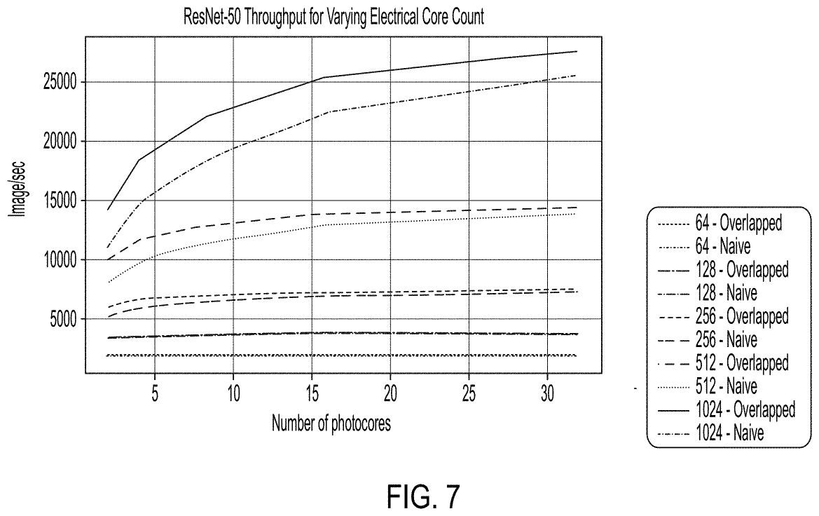

FIG. 7 is a plot illustrating the throughput of a ResNet-50 deep neural network according to data pipelining, in accordance with some embodiments. The throughput is represented in images per second in this example. The plot illustrates the throughput as a function of the number of analog accelerator cores. The different lines represent 64, 128, 256, 512 and 1024 digital operations, respectively. The solid lines (“overlapped”) are obtained using the pipelined techniques described in this section and the dashed lines (“naïve”) are obtained using a naive pipelining strategy, where the digital nonlinear operations are only started when the entire output matrix has been calculated. As can be appreciated from FIG. 7, using the pipelining techniques described herein yield a significant increase in throughput.

### V. Layer Pipelining

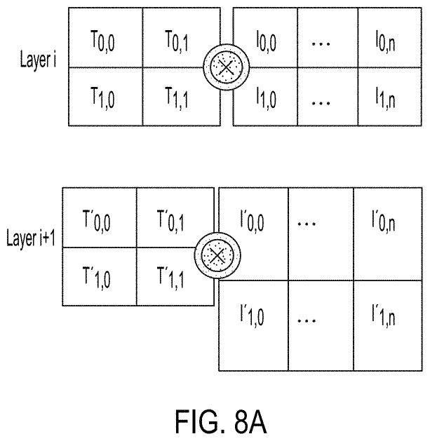

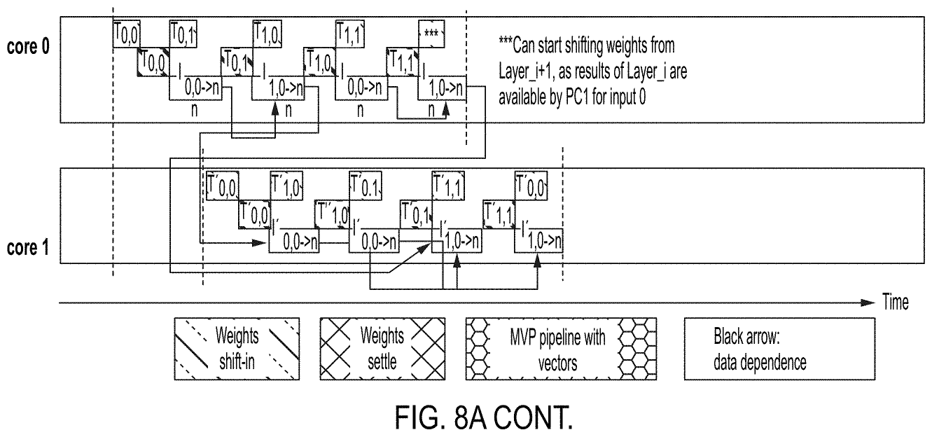

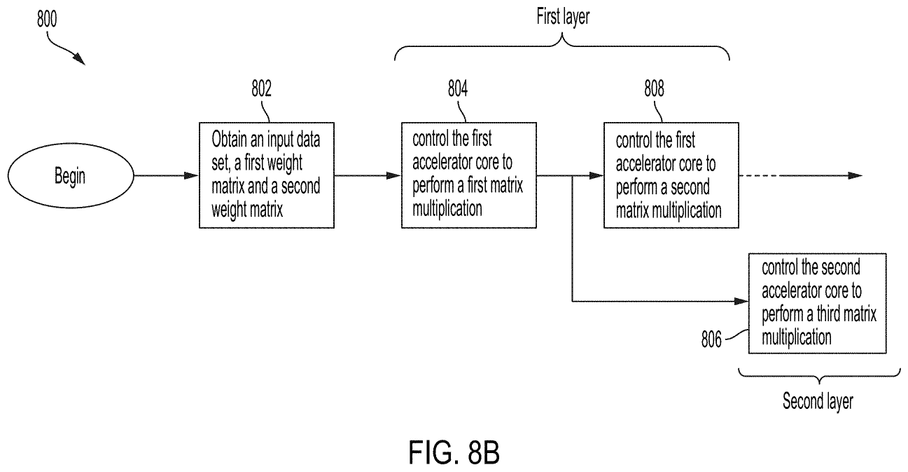

The inventors have further appreciated that the evaluation of a neural network can be pipelined on a layer-by-layer basis. For example, pipelining may be performed between a layer and the following layers. FIG. 8A is a diagram illustrating how layer pipelining may be performed in some embodiments. In this example, a pair of layers of a neural network are depicted. Layer i defines a multiplication between weight matrix T and input matrix I and layer i+1 defines a multiplication between weight matrix T′ and input matrix I′. Layer i+1 and layer I may be adjacent to one another. In this example, two analog accelerator cores are considered, core 0 and core 1. Of course, layer pipelining may be extended to any suitable number of cores. Core 0 processes layer I and core 1 processed core i+1.

The inventors have recognized that it may be unnecessary to wait for the entire evaluation of a layer to be completed before an output can be passed to the subsequent layer. Whenever parts of the output have been successfully calculated for a given layer, those parts can be immediately passed onto the next layer. Layer pipelining allows a computing system to overlap the computation of one layer significantly with the computation of the next layers—thereby increasing the throughput of the overall system.

FIG. 8B is a flowchart illustrating a representative process involving layer pipelining, in accordance with some embodiments. At step 802, a controller coupled to a plurality of analog processor cores obtains an input data set, a first weight matrix associated with a first layer of a multi-layer neural network, and a second weight matrix associated with a second layer of the multi-layer neural network. With reference to FIG. 8A, for example, the controller may receive weight matrix T and input matrix I associated with layer i, and may further receive weight matrix T′ associated with layer i+1.

At step 804, the controller controls the first accelerator core to perform a first matrix multiplication to produce a first output data block using a first portion of the first weight matrix and at least a first portion of the input data set. For example, with reference to FIG. 8A, the controller may multiply the row corresponding to tiles T_{0,0} and T_{0,1} by a column of matrix I using core 0.

At step 806, the controller controls the second accelerator core to perform a third matrix multiplication using the second weight matrix and the first output data block. For example, with reference to FIG. 8A, the controller may multiply the row corresponding to tiles T′_{0,0} and T′_{0,1} by a column of matrix I′ using core 1. The entries of such a column of matrix I′ may be generated based on the first output data block obtained at step 804.

At step 808, the controller controls the first accelerator core to perform a second matrix multiplication to produce a second output data block using a second portion of the first weight matrix and at least a second portion of the input data set. For example, with reference to FIG. 8A, the controller may multiply the row corresponding to tiles T_{1,0} and T1,₁ by a column of matrix I using core 0. It should be noted that step 806 occurs subsequent to completion of the first matrix multiplication (step 804) but prior to completion of the second matrix multiplication (step 808).

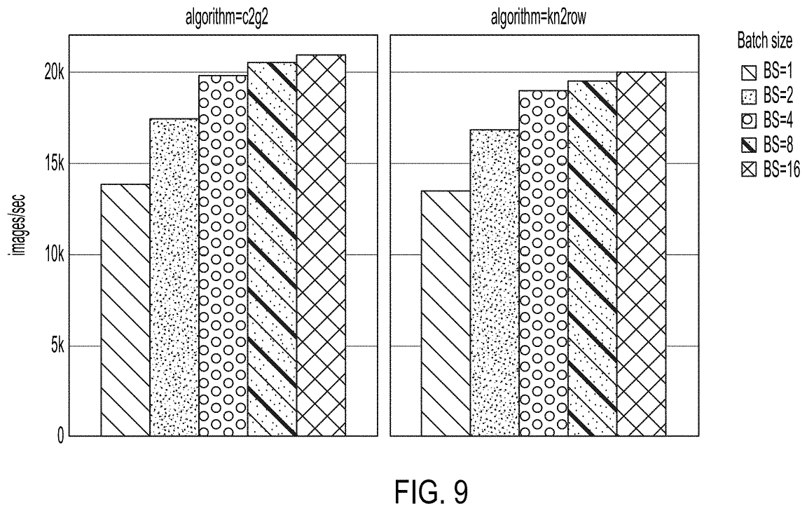

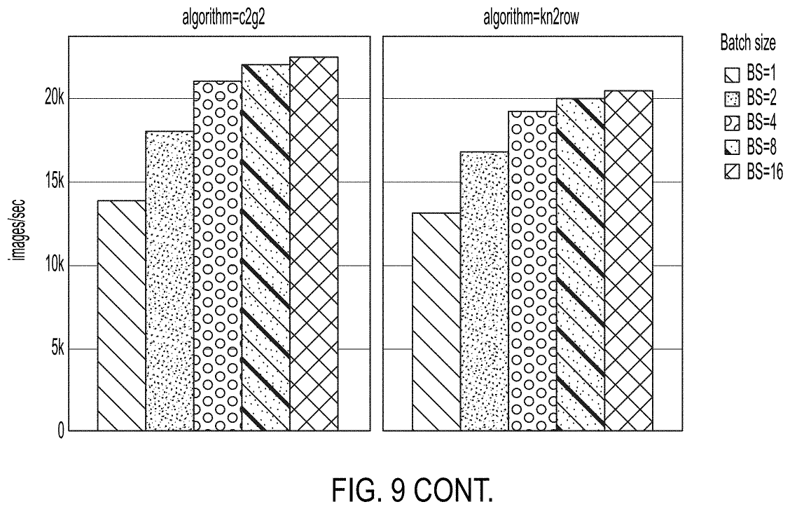

FIG. 9 shows a comparison between the throughput of a ResNet-50 neural network when evaluated using two analog accelerator cores without using layer pipelining (top left and top right) and using layer pipelining (bottom left and bottom right). FIG. 9 shows the evaluation for two different algorithms, “c2g2” and “kn2row” for different batch sizes (1, 2, 4, 8 and 16). As can be appreciated from FIG. 9, layer pipelining produces a significant increase in throughput.

### VI. Additional Comments

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The definitions, as defined and used herein, should be understood to control over dictionary definitions, definitions in documents incorporated by reference and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some case and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately,” “substantially,” and “about” may be used to mean within ±20% of a target value in some embodiments. The terms “approximately,” “substantially,” and “about” may include the target value.

Use of ordinal terms such as “first,” “second,” “third,” etc., in the claims to modify a claim element does not by itself connotate any priority, precedence, or order of one claim element over another or the temporal order in which acts of a method are performed, but are used merely as labels to distinguish one claim element having a certain name from another claim element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. A processing system, comprising
an analog accelerator arranged to perform matrix multiplication;
a digital processor; and
a controller coupled to both the analog accelerator and the digital processor, wherein the controller is configured to:
obtain an input data set and a weight matrix;
control the analog accelerator to perform a first matrix multiplication to produce a first output data block using a first portion of the weight matrix and at least a first portion of the input data set;
control the analog accelerator to perform a second matrix multiplication to produce a second output data block using a second portion of the weight matrix and at least a second portion of the input data set; and
subsequent to completion of the first matrix multiplication and prior to completion of the second matrix multiplication, control the digital processor to process the first output data block using a non-linear operation.

2. The processing system of claim 1, wherein the analog accelerator has a first accelerator core and a second accelerator core, wherein the controller is further configured to:
control the analog accelerator to perform the first matrix multiplication using the first accelerator core; and
control the analog accelerator to perform the second matrix multiplication using the second accelerator core.

3. The processing system of claim 1, wherein the digital processor is configured to complete the processing of the first output data block prior to completion of the second matrix multiplication.

4. The processing system of claim 1, wherein the first portion of the weight matrix comprises at least a first row of the weight matrix, and wherein the controller is configured to control the analog accelerator to perform the first matrix multiplication to produce the first output data block using the first row of the weight matrix.

5. The processing system of claim 4, wherein the second portion of the weight matrix comprises at least a second row of the weight matrix, and wherein the controller is configured to control the analog accelerator to perform the second matrix multiplication to produce the second output data block using the second row of the weight matrix.

6. The processing system of claim 1, wherein the controller is configured to control the analog accelerator to perform the first matrix multiplication using tile parallelism.

7. The processing system of claim 1, wherein the controller is configured to control the analog accelerator to perform the first matrix multiplication using data parallelism.

8. The processing system of claim 1, wherein the analog accelerator comprises a photonic accelerator, and wherein the analog accelerator is configured to perform the first matrix multiplication at least partially in an optical domain.

9. The processing system of claim 8, wherein the photonic accelerator comprises an optical multiplier configured to perform scalar multiplication in the optical domain.

10. The processing system of claim 8, wherein the photonic accelerator comprises an optical adder configured to perform scalar addition in the optical domain.

11. A method for processing data using a processing system comprising an analog accelerator arranged to perform matrix multiplication and a digital processor, the method comprising:
obtaining an input data set and a weight matrix;
controlling the analog accelerator to perform a first matrix multiplication to produce a first output data block using a first portion of the weight matrix and at least a first portion of the input data set;
controlling the analog accelerator to perform a second matrix multiplication to produce a second output data block using a second portion of the weight matrix and at least a second portion of the input data set; and
subsequent to completion of the first matrix multiplication and prior to completion of the second matrix multiplication, controlling the digital processor to process the first output data block using a non-linear operation.

12. The method of claim 11, wherein the analog accelerator has a first accelerator core and a second accelerator core, wherein:
controlling the analog accelerator to perform the first matrix multiplication comprises controlling the first accelerator core to perform the first matrix multiplication; and
controlling the analog accelerator to perform the second matrix multiplication comprises controlling the second accelerator core to perform the second matrix multiplication.

13. The method of claim 11, further comprising completing the processing of the first output data block prior to completion of the second matrix multiplication.

14. A processing system configured to process a multi-layer neural network comprising first and second layers, the processing system comprising:
a multi-core analog accelerator comprising first and second accelerator cores; and
a controller coupled to the multi-core analog accelerator and configured to:
obtain an input data set, a first weight matrix associated with the first layer of the multi-layer neural network, and a second weight matrix associated with the second layer of the multi-layer neural network;
process the first layer of the multi-layer neural network, wherein processing the first layer comprises:
controlling the first accelerator core to perform a first matrix multiplication to produce a first output data block using a first portion of the first weight matrix and at least a first portion of the input data set; and
controlling the first accelerator core to perform a second matrix multiplication to produce a second output data block using a second portion of the first weight matrix and at least a second portion of the input data set; and
process the second layer of the multi-layer neural network, wherein processing the second layer comprises:
subsequent to completion of the first matrix multiplication and prior to completion of the second matrix multiplication, controlling the second accelerator core to perform a third matrix multiplication using the second weight matrix and the first output data block.

15. The processing system of claim 14, wherein the controller is further configured to control the second accelerator core to complete the third matrix multiplication subsequent to completion of the second matrix multiplication by the first accelerator core.

16. The processing system of claim 14, wherein the first portion of the first weight matrix comprises at least a first row of the first weight matrix, and wherein the controller is configured to control the first accelerator core to perform the first matrix multiplication to produce the first output data block using the first row of the first weight matrix.

17. The processing system of claim 16, wherein the second portion of the first weight matrix comprises at least a second row of the first weight matrix, and wherein the controller is configured to control the first accelerator core to perform the second matrix multiplication to produce the second output data block using the second row of the first weight matrix.

18. The processing system of claim 17, wherein the controller is configured to control the first accelerator core to perform the first matrix multiplication using tile parallelism.

19. The processing system of claim 14, wherein the controller is configured to control the first accelerator core to perform the first matrix multiplication using data parallelism.

20. The processing system of claim 14, wherein the first accelerator core comprises a first photonic core and the second accelerator core comprises a second photonic core, and wherein:
controlling the first accelerator core to perform the first matrix multiplication comprises controlling the first photonic core to perform the first matrix multiplication in an optical domain; and
controlling the second accelerator core to perform the second matrix multiplication comprises controlling the second photonic core to perform the second matrix multiplication in the optical domain.
